(19) United States
(12) Patent Application Publication
(10) Pub. No.: US 2011/0237709 A1
(43) Pub. Date: Sep. 29, 2011

(54) PRODUCTION OF MOLDED FIBROUS BASIC MAGNESIUM SULFATE FILLER-CONTAINING OLEFIN POLYMER COMPOSITION PRODUCTS

(75) Inventors: Atsushi TAKEUCHI, Wako-shi (JP); Shinichi Yamamoto, Ube-shi (JP); Takashi Kishimoto, Ube-shi (JP)

(73) Assignees: HONDA MOTOR CO., LTD., Tokyo (JP); UBE MATERIAL INDUSTRIES, LTD., Ube-shi (JP)

(21) Appl. No.: 13/071,609

(22) Filed: Mar. 25, 2011

(30) Foreign Application Priority Data
Mar. 26, 2010 (JP) 2010-072941

(51) Int. Cl. C08K 13/04; C08J 3/22; C08K 13/02; C08L 23/02

(52) U.S. Cl. 523/351; 524/269; 524/394

(57) ABSTRACT

A molded fibrous basic magnesium sulfate filler-containing olefin polymer composition product is produced by a process comprising the steps of preparing a fibrous basic magnesium sulfate filler-containing master batch composition which comprises an olefin polymer, a fibrous basic magnesium sulfate filler, an elastomer, a fatty acid metal salt and a hydrocarbon or silicone oil or a hydrocarbon or silicone wax; mixing the master batch composition and a propylene polymer-containing diluent resin; kneading the resulting mixture in a molten state; and molding the molten mixture to give the molded product.

### FIELD OF THE INVENTION

The present invention relates to a process for producing a molded fibrous basic magnesium sulfate filler-containing olefin polymer composition product. The invention further relates to a fibrous basic magnesium sulfate filler-containing master batch composition favorably employable for performing the process of the invention.

### BACKGROUND OF THE INVENTION

Propylene polymers are thermoplastic and hence can be melted by heating and molded to give articles having various shapes. Therefore, the propylene polymers are widely employed, for instance, for producing sheathing parts of automobiles, housings of household electric appliances such as refrigerators and washing machines, and other various molded products such as trays, shelf plates and wrapping films. It is known that the propylene polymers are mixed with additives such as inorganic fillers, lubricants and elastomers so as to improve rigidity and impact strength of the molded, products. As the inorganic fillers, there are known fibrous inorganic fillers such as a fibrous basic magnesium sulfate filler and non-fibrous fillers such as talc. Basic magnesium sulfate has the chemical formula of MgSO₄.5Mg(OH)₂.3H₂O.

JP 2006-83369A (corresponding to US 2006/0052544 A1) describes a method for producing a propylene-based resin composition comprising a first step of producing a first resin composition (MB) by melt-kneading a first-propylene polymer (A-I) and a fibrous inorganic filler (B) in a weight ratio of (A-I) to (B) of from 3/7 to 7/3; and a second step of producing a second resin composition by adding a second propylene polymer (A-II), a non-fibrous inorganic filler (C) and an elastomer (D) selected from the group consisting of olefin-based elastomer and vinyl aromatic compound-containing elastomer to the first resin composition (MB), followed by melt kneading them. In the working examples, the first resin composition (i.e., master batch composition) contains a lubricant.

There are cases in which molded products made from an olefin polymer composition are desired to show further increased impact strength. For instance, bumpers and other sheathing parts of automobiles for driving at low temperatures are desired to show high impact strengths such as high izod impact strength and surface impact strength at low temperatures such as lower than 0° C., keeping the high modulus in flexure.

### SUMMARY OF THE INVENTION

Accordingly, it is an object of the invention to provide a process for producing an olefin polymer composition product showing high izod impact strength and surface impact strength at low temperatures such as lower than 0° C., keeping the high modulus in flexure.

The present inventors have found that molded products produced from an olefin polymer composition show favorably high izod impact strength and surface impact strength at low temperatures, keeping the high modulus in flexure, if the molded product is produced using a master batch olefin composition comprising an elastomer, a metal salt of a fatty acid, and a hydrocarbon or silicone oil or a hydrocarbon or silicone wax in addition to the olefin polymer and fibrous basic magnesium sulfate filler.

From one aspect, the present invention provides a process for producing a molded fibrous basic magnesium sulfate filler-containing olefin polymer composition product which comprises the steps of:

preparing a fibrous basic magnesium sulfate filler-containing master batch composition which comprises the following components:

(A) an olefin polymer,

(B) a fibrous basic magnesium sulfate filler,

(C) an elastomer,

(D) a metal salt of a fatty acid, and

(E) a hydrocarbon or silicone oil or a hydrocarbon or silicone wax;

mixing 100 weight parts of the fibrous basic magnesium sulfate-containing master batch composition and 100 to 2,000 weight parts of a diluent resin containing a propylene polymer, to give a mixture;

kneading the resulting mixture in a molten state, to give a molten mixture; and

molding the molten mixture to give the molded product.

From another aspect, the invention provides the above-mentioned fibrous basic magnesium sulfate filler-containing master batch composition.

### EMBODIMENTS OF THE INVENTION

The preferred embodiments of the process and master batch composition of the invention are described below.

1. The master batch composition comprises the component (A) in an amount of 1 to 45 weight parts, the component (B) in an amount of 35 to 80 weight parts, and the component (C) in an amount of 5 to 45 weight parts under the condition that the total amount of the components (A), (B) and (C) is 100 weight parts, and the component (D) in an amount of 0.01 to 15.0 weight parts and the component (E) in an amount of 0.01 to 15.0 weight parts under the condition that the amount of the component (D) is in the range of 0.02 to 20.0 weight parts and the amount of the component (E) is in the range of 0.02 to 20.0 weight parts, per 100 weight parts of the component (B).

2. The component (A) is at least one olefin polymer selected from the group consisting of a propylene polymer, an ethylene polymer, and an ethylene-propylene copolymer.

3. The component (B) is a fibrous basic magnesium sulfate has a thickness in the range of 0.1 to 1.0 μm and an average aspect ratio of 5 or more.

4. The component (C) is at least one elastomer selected from the group consisting of an ethylene-butene elastomer, an ethylene-octene elastomer and a styrenic unit-containing elastomer.

5. The component (D) is a metal salt of a fatty acid having 12 to 22 carbon atoms.

6. The component (E) is a hydrocarbon or silicone oil having a boiling point of 250° C. or higher and a decomposition temperature of 250° C. or higher or a hydrocarbon or silicone wax having a melting point not higher than 200° C., a boiling point of 250° C. or higher and a decomposition temperature of 250° C. or higher.

7. The component (E) is selected from the group consisting of liquid paraffin, silicone oil, paraffin wax, microcrystalline wax, polyethylene wax and silicone wax.

8. The master batch composition contains the component (D) in an amount of 0.1 to 5.0 weight parts per the total amount of the components (A), (B) and (C) and in an amount of 0.2 to 7.0 weight parts per 100 weight parts of the component (B).

9. The master batch composition contains the component (E) in an amount of 0.03 to 10.0 weight parts per the total amount of the components (A), (B) and (C) and in an amount of 0.06 to 15.0 weight parts per 100 weight parts of the component (B).

The components (A), (B), (C), (D), and (E) are further described below.

(A) Olefin Polymer

The olefin polymer preferably shows a melt flow index (MFR) in the range of 3 to 300 g/10 min., determined by the method described in ASTM-D1238 at a temperature of 230° C. and a load of 2.16 kg. Examples of the olefin polymer include ethylene polymers, propylene polymers and ethylene-propylene copolymers. The propylene polymer can be an inherently crystalline propylene homo-polymer or an inherently crystalline propylene-1-olefin copolymer comprising not less than 50 mol. % of propylene unit. The olefin polymers can be employed singly or in combination.

(B) Fibrous Basic Magnesium Sulfate Filler

The fibrous basic magnesium sulfate filler preferably has a mean thickness in the range of 0.1 to 1.0 μm and a mean aspect ratio (mean length/mean thickness) of not less than 5, particularly in the range of 5 to 50. The mean length and mean thickness can be determined from an enlarged SEM (Scanning Electron microscope) image. The fibrous basic magnesium sulfate filler may be in the form of aggregated mass or coagulated mass.

(C) Elastomer

Examples of the elastomer include an ethylene-α-olefin elastomer and a styrenic elastomer, that is, a styrenic unit-containing elastomer. The elastomer can be employed singly or in combination.

The ethylene-α-olefin elastomer can be a copolymer of ethylene and α-olefin and a copolymer of ethylene, α-olefin and non-conjugated diene. Examples of the α-olefin include 1-butene, 1-pentene, 1-hexene, 1-heptene and 1-octene. Examples of the non-conjugated diene include dicyclopentadiene, 1,4-hexadiene, cyclooctadiene, di-cyclooctadiene, methylenenorbornene, 5-ethylidene-2-norbornene, 5-vinyl-2-norbornene, 5-methylene-2-norbornene, 5-methyl-1,4-hexadiene and 7-methyl-1,6-octadiene.

Examples of the ethylene-α-olefin elastomer include ethylene-propylene rubber (EPR), ethylene-1-butene rubber (EBR), ethylene-1-octene rubber (EOR), ethylene-propyl-ene-nonconjugated diene elastomer (EPDM), ethylene-propylene-1-butene rubber (EPBR), elastic ethylene-1-butene-nonconjugated copolymer (EBDM) and ethylene-propylene-1-butene-nonconjugated diene elastomer (EPBDM). Preferred are ethylene-butene elastomers comprising ethylene and 1-butene and ethylene-octene elastomers comprising ethylene and 1-octene.

The ethylene-α-olefin elastomer generally shows a melt flow rate (MFR determined by the method described in ASTM-D1238, temperature: 190° C., load: 2.16 kg) of not less than 0.1 g/10 min., preferably in the range of 0.3 to 20 g/10 min.

The styrenic elastomer can be a block copolymer comprising styrenic compound polymer blocks and conjugated diene polymer blocks or a hydrogenated block copolymer having the conjugated diene unit whose the double bond is hydrogenated.

Examples of the styrenic elastomer include block copolymers such as styrene-butadiene rubber (SBR), styrene-butadiene-styrene block copolymer elastomer (SBS), styrene-isoprene-styrene block copolymer elastomer (SIS) and styrene-ethylene-propylene-styrene copolymer elastomer (SEPS) and their hydrogenated block copolymers.

The styrenic elastomer generally shows a melt flow rate (MFR determined by the method described in ASTM-D1238, temperature: 230° C., load: 2.16 kg) of not less than 0.1 g/10 min., preferably in the range of 0.1 to 100 g/10 min., more preferably in the range of 0.5 to 20 g/10 min.

Particularly preferred are EBR, EOR and SEPS.

(D) Metal Salt of Fatty Acid

The metal salt of a fatty acid preferably is a metal salt of a fatty acid having 12 to 22 carbon atoms. The fatty acid can be a saturated fatty acid or an unsaturated fatty acid. Examples of the saturated fatty acid include lauric acid, tridecanoic acid, myristic acid, pentadecanoic acid, palmitic acid, margaric acid (i.e., heptadecanoic acid), stearic acid, nonadecanoic acid, arachidic acid, and behenic acid. Examples of the unsaturated fatty acid include myristoleic acid, palmitoleic acid, oleic acid, eraidic acid, vaccenic acid (i.e., trans-11-octadecenic acid), gadoleic acid (i.e., 9-eicosenoic acid), and erucic acid (i.e., cis-13-docosenoic acid).

Examples of a metal include lithium, potassium, sodium, magnesium, calcium, zinc, copper, lead, aluminum, iron, cobalt, chromium and manganese.

The metal salt of a fatty acid preferably is magnesium stearate or calcium stearate. The metal salt of a fatty acid can be employed singly or in combination.

(E) Hydrocarbon or silicone oil and hydrocarbon or silicone wax

The hydrocarbon or silicone oil preferably is liquid at room temperature and does not boil and decompose when the propylene resin composition is heated for molding. Therefore, the hydrocarbon or silicone oil preferably has a boiling point of 250° C. or higher and a decomposition temperature of 250° C. or higher. The hydrocarbon or silicone wax preferably converts into liquid and does not boil and decompose when the propylene resin composition is heated for molding. Therefore, the hydrocarbon or silicone wax preferably has a melting point not higher than 200° C., a boiling point of 250° C. or higher and a decomposition temperature of 250° C. or higher.

The hydrocarbon oil and wax preferably comprises one or more saturated straight chain hydrocarbon. The hydrocarbon oil preferably is liquid paraffin. The hydrocarbon wax preferably is paraffin wax, microcrystalline wax or polyethylene wax.

The silicone oil preferably comprises one or more straight chain polysiloxane. The silicone oil preferably is dimethylsilicone oil or methylphenylsilicone oil. The silicone wax preferably comprises one or more alkylated polysiloxane. The hydrocarbon oil and wax and silicone oil wax can be employed singly or in combination.

The procedures involved in the process for producing a molded fibrous basic magnesium sulfate filler-containing olefin polymer composition product are described below in more detail.

The master batch composition preferably is in the form of pellets, particularly cylindrical pellets. The cylindrical pellets preferably have a diameter in the range of 1 to 5 mm and a length in the range of 1 to 5 mm. It is preferred that 50 pellets have a weight of 0.5 to 5.0 g.

In the process of the invention, the master batch composition is mixed with a diluent resin containing a propylene polymer (mixing ratio: 100 to 2,000, by weight), to give a mixture. The resulting mixture is kneaded in a molten state and molded to give a molded product according to the conventionally known procedures. The mixing and kneading in the above-mentioned procedure can be simultaneously performed.

It is the inventors' understanding that the fibrous basic magnesium sulfate filler is dispersed in the master batch composition in the form of pellets according to the invention under highly uniform state probably due to the incorporation of the additional three components including (C) an elastomer, (D) a fatty acid metal salt and (E) a hydrocarbon oil or wax or a silicone oil or wax. Therefore, when the master batch pellets are mixed with a diluent resin and kneaded under heating, the fibrous basic magnesium sulfate filler having been dispersed in the master batch pellets is smoothly and rapidly dispersed in the kneaded mixture. For this reason, the molded product produced from the kneaded mixture employing the master batch pellets shows increased impact strengths.

The diluent resin can comprises essentially a propylene polymer alone or can comprise a propylene polymer and a relatively small amount of one or more of other thermoplastic polymers such as other olefin polymers. The diluent resin can contain a non-fibrous inorganic filler and/or an elastomer in addition to the polymeric material. For instance, when the outer parts of automobiles such as a bumper are produced, the diluent resin preferably is in the form of a composition comprising a propylene polymer (30 to 80 wt. %), a non-fibrous inorganic filler (5 to 40 wt. %), and an elastomer (5 to 60 wt. %).

In the above-mentioned diluent resin composition, the non-fibrous inorganic filler can be talc, mica, calcium carbonate, barium sulfate, magnesium carbonate, clay, alumina, silica, calcium sulfate, magnesium hydroxide, dolomite, glass flakes, glass balloons, glass beads, calcium silicate, smectite, montmorillonite, bentonite, kaolinite, carbon black, or titanium dioxide. Preferred is talc. The non-fibrous inorganic filler preferably has a mean size in the range of 0.1 to 10 μm, more preferably in the range of 0.1 to 5 μm. The mean size of the filler can be determined by a laser diffraction method.

The elastomer employable as a component of the diluent resin composition can be the same as the elastomer which is described hereinbefore as the component of the master batch composition. However, the elastomer in the diluent resin composition can be the same as or different from the elastomer for the master batch composition.

If desired, the diluent resin composition can contain, other additives such as an oxidation inhibitor, a UV absorber, a pigment, an anti static agent, a copper inactivating agent, a flame retardant, other lubricants, a neutralizing agent, a forming agent, a plasticizer, an anti-forming agent, and a cross-linking agent.

The molding can be performed by the known procedures such as injection molding, extrusion molding, calendering, blow molding, foam molding, and centrifugal molding.

The finally produced molded product preferably contains the fibrous basic magnesium sulfate filler in an amount of 2 to 15 wt. %.

The invention is further described by the following non-limiting examples.

### EXAMPLE 1

### (1) Production of Master Batch Pellets

Ten (10) weight parts of a propylene polymer (MFR determined at 230° C. and 2.16 kg: 49.4 g/10 min.), 70 weight parts of a fibrous basic magnesium sulfate filler (mean length: 15 μm, mean thickness: 0.5 μm), 20 weight parts of an elastic styrene-ethylene-propylene-styrene block copolymer (SEPS, MFR determined at 230° C. and 2.16 kg: 5.0 g/10 min.), 1.47 weight parts of magnesium stearate, and 0.07 weight part of dimethylsilicone oil (SH 200-1000CS, available from Toray Dow Corning Co., Ltd., weight average molecular weight 17,000) were placed in a tumbler and dry-blended. The blended mixture was then kneaded in a double-screw kneader at 200° C. and subsequently extruded in the form of strands having a diameter of 3 mm. The strands were intermittently cut to give master batch pellets having a length of 3 mm.

### (2) Production of Diluent Resin Pellets

sixty two (62) weight parts of a propylene polymer (MFR determined at 230° C. and 2.16 kg: 50.0 g/10 min.), 30 weight parts of an elastic ethylene-1-butene copolymer (EBR, MFR determined at 190° C. and 2.16 kg: 5.0 g/10 min.), 8 weight parts of talc (mean size: 4.7 μm), and 0.1 weight part of calcium stearate were placed in a tumbler and dry-blended. The blended mixture was then kneaded in a double-screw kneader at 200° C. and subsequently extruded in the form of strands having a diameter of 3 mm. The strands were intermittently cut to give diluent resin pellets having a length of 3 mm.

### (3) Production of Propylene Resin Composition Molded Product

The master batch pellets (7.4 weight parts) produced in (1) above and the diluent resin pellets (92.6 weight parts) produced in (2) above were mixed and placed in an injection molding machine (heated to 200° C.) to produce test pieces of the propylene resin composition molded product.

### EXAMPLES 2 and 3

The procedures of Example 1 were repeated except for employing master batch pellets produced using the dimethylsilicone oil in an amount of 0.70 weight part (for Example 2) or 7.00 weight parts (for Example 3), to produce test pieces of the propylene resin composition molded product.

### EXAMPLE 4

The procedures of Example 1 were repeated except for employing master batch pellets produced using 0.70 weight part of dimethylsilicone oil (SH 200-100CS, available from Toray Dow Corning Co., Ltd., weight average molecular weight 5,000) in place of the dimethylsilicone oil (SH 200-1000CS), to produce test pieces of the propylene resin composition molded product.

### EXAMPLE 5

The procedures of Example 1 were repeated except for employing master batch pellets produced using 0.70 weight part of paraffin wax (125 Paraffin (NOC), available from Nippon Oil Corporation, m.p. 53° C., weight average molecular weight 381) in place of the dimethylsilicone oil (SH 200-1000CS), to produce test pieces of the propylene resin composition molded product.

### EXAMPLE 6

The procedures of Example 1 were repeated except for employing master batch pellets produced using 0.70 weight part of paraffin wax (145 Paraffin (NOC), available from Nippon Oil Corporation, m.p. 63° C., weight average molecular weight 438) in place of the dimethylsilicone oil (SH 200-1000CS), to produce test pieces of the propylene resin composition molded product.

### Comparison Example 1

The procedures of Example 1 were repeated except for employing a master batch pellets produced using the propylene polymer in an amount of 30 weight parts and using neither elastomer nor dimethylsilicone oil, to produce test pieces of the propylene resin composition molded product.

### Evaluation

The test pieces produced in Examples 1 to 6 and Comparison Example 1 were subjected to determinations of Izod impact strength, Dupont impact strength (surface impact strength) and modulus in flexure by the below-described methods.

(1) Izod Impact Strength
The Izod impact strength was determined by the method described in ASTM-D256 at −30° C.

(2) Dupont Impact Strength
The Dupont impact strength was determined using a test piece (80mm×80mm×3 mm). The test piece was allowed to stand at −30° C. for 5 hours. Subsequently, the test piece was subjected to the determination of a Dupont impact strength by means of a Dupont impact strength-measuring apparatus having a hammer (radius: 6.35±0.03 mm) and a pending weight (6 kg) under the condition of the maximum weight drop height of 90 cm. The measurement was done using five test pieces.

In the measurement, the weight was dropped onto the test piece from increasing heights. When no cracks were observed on every test piece at the highest drop height, the drop height (cm) was checked. The Dupont impact strength (kgf·cm) was then obtained using the formula of the highest drop height (cm)×weight (6 kg) of the dropped weight. If no cracks were observed in test pieces when the weight was dropped onto the test pieces from the maximum height, a Dupont impact strength of the test pieces was more than 540 kgf·cm (>540 kgf·cm).

(3) Modulus in Flexure

The modulus in flexure was determined in accordance with the procedures described in ASTM D790.

TABLE 1

| | | | |
|---|---|---|---|
| Composition of MB pellets | Izod | Dupont | Modulus |

| | (A) | (B) | (C) | (D) | (E) | (J/m) | (kgf · cm) | (MPa) |
|---|---|---|---|---|---|---|---|---|
| Example 1 | 10 | 70 | 20 | 1.47 | 0.07 | 98.7 | >540 | 2150 |
| Example 2 | 10 | 70 | 20 | 1.47 | 0.70 | 98.9 | >540 | 2153 |
| Example 3 | 10 | 70 | 20 | 1.47 | 7.00 | 99.9 | >540 | 2208 |
| Example 4 | 10 | 70 | 20 | 1.47 | 0.70 | 85.8 | >540 | 2114 |
| Example 5 | 10 | 70 | 20 | 1.47 | 0.70 | 83.8 | >540 | 2104 |
| Example 6 | 10 | 70 | 20 | 1.47 | 0.70 | 85.2 | >540 | 2124 |
| Com. Ex. 1 | 30 | 70 | 0 | 1.47 | 0 | 68.1 | 300 | 2311 |

Remarks:
MB pellets: Master batch pellets
(A): Propylene polymer
(B): Fibrous basic magnesium sulfate filler
(C): Elastomer
(D): Fatty acid metal salt
(E): Oil or wax of hycrocarbon or silicone
Izod: Izod impact strength
Dupont: Dupont impact strength
Modulus: Modulus in flexure

As is clear from the experimental data set forth in Table 1, the propylene resin composition molded products produced employing the master batch compositions according to the invention (Examples 1 to 6) show higher impact strengths (Izod impact strength as well as Dupont impact strength (surface impact strength)) at such a low temperature as −30° C., as compared with the propylene resin composition molded products produced employing the master batch compositions containing neither elastomer nor filler-surface treating agent (Comparison Example 1). As for the modulus in flexure showing rigidity of a molded product, the propylene resin composition molded products produced employing the master batch compositions according to the invention (Examples 1 to 6) show satisfactory values from the viewpoint of practical use.

What is claimed is:

1. A process for producing a molded fibrous basic magnesium sulfate filler-containing olefin polymer composition product which comprises the steps of:
preparing a fibrous basic magnesium sulfate filler-containing master batch composition which comprises the following components:
(A) an olefin polymer,
(B) a fibrous basic magnesium sulfate filler,
(C) an elastomer,
(D) a metal salt of a fatty acid, and
(E) a hydrocarbon or silicone oil or a hydrocarbon or silicone wax;
mixing 100 weight parts of the fibrous basic magnesium sulfate-containing master batch composition and 100 to 2,000 weight parts of a diluent resin containing a propylene polymer, to give a mixture;
kneading the resulting mixture in a molten state, to give a molten mixture; and
molding the molten mixture to give the molded product.

2. The process of claim 1, wherein the master batch composition comprises the component (A) in an amount of 1 to 45 weight parts, the component (B) in an amount of 35 to 80 weight parts, and the component (C) in an amount of 5 to 45 weight parts under the condition that the total amount of the components (A), (E) and (C) is 100 weight parts, and the component (D) in an amount of 0.01 to 15.0 weight parts and the component (E) in an amount of 0.01 to 15.0 weight parts under the condition that the amount of the component (D) is in the range of 0.02 to 20.0 weight parts and the amount of the component (E) is in the range of 0.02 to 20.0 weight parts, per 100 weight parts of the component (B).

3. The process of claim 1, wherein the component (A) is at least one olefin polymer selected from the group consisting of a propylene polymer, an ethylene polymer, and an ethylene-propylene copolymer.

4. The process of claim 1, wherein the component (B) is a fibrous basic magnesium sulfate filler has a thickness in the range of 0.1 to 1.0 μm and an average aspect ratio of 5 or more.

5. The process of claim 1, wherein the component (C) is at least one elastomer selected from the group consisting of an ethylene-butene elastomer, an ethylene-octene elastomer and a styrenic unit-containing elastomer.

6. The process of claim 1, wherein the component (D) is a metal salt of a fatty acid having 12 to 22 carbon atoms.

7. The process of claim 1, wherein the component (E) is a hydrocarbon or silicone oil having a boiling point of 250° C. or higher and a decomposition temperature of 250° C. or higher or a hydrocarbon or silicone wax having a melting point not higher than 200° C., a boiling point of 250° C. or higher and a decomposition temperature of 250° C. or higher.

8. The process of claim 1, wherein the component (E) is selected from the group consisting of liquid paraffin, silicone oil, paraffin wax, microcrystalline wax, polyethylene wax and silicone wax.

9. A fibrous basic magnesium sulfate filler-containing master batch composition which comprises the following components:
(A) an olefin polymer,
(B) a fibrous basic magnesium sulfate filler,
(C) an elastomer,
(D) a metal salt of a fatty acid, and
(E) a hydrocarbon or silicone oil or a hydrocarbon or silicone wax;
wherein the batch composition comprises the component (A) in an amount of 1 to 45 weight parts, the component (B) in an amount of 35 to 80 weight parts, and the component (C) in an amount of 5 to 45 weight parts under the condition that the total amount of the components (A), (B) and (C) is 100 weight parts, and the component (D) in an amount of 0.01 to 15.0 weight parts and the component (E) in an amount of 0.01 to 15.0 weight parts under the condition that the amount of the component (D) is in the range of 0.02 to 20.0 weight parts and the amount of the component (E) is in the range of 0.02 to 20.0 weight parts, per 100 weight parts of the component (B).

10. The fibrous basic magnesium sulfate filler-containing master batch composition of claim 9, wherein the component (A) is at least one olefin polymer selected from the group consisting of a propylene polymer, an ethylene polymer, and an ethylene-propylene copolymer.

11. The fibrous basic magnesium sulfate filler-containing master batch composition of claim 9, wherein the component (B) is a fibrous basic magnesium sulfate has a thickness in the range of 0.1 to 1.0 μm and an average aspect ratio of 5 or more.

12. The fibrous basic magnesium sulfate filler-containing master batch composition of claim 9, wherein the component (C) is at least one elastomer selected from the group consisting of an ethylene-butene elastomer, an ethylene-octene elastomer and a styrenic unit-containing elastomer.

13. The fibrous basic magnesium sulfate filler-containing master batch composition of claim 9, wherein the component (D) is a metal salt of a fatty acid having 12 to 22 carbon atoms.

14. The fibrous basic magnesium sulfate filler-containing master batch composition of claim 9, wherein the component (E) is a hydrocarbon or silicone oil having a boiling point of 250° C. or higher and a decomposition temperature of 250° C. or higher or a hydrocarbon or silicone wax having a melting point not higher than 200° C., a boiling point of 250° C. or higher and a decomposition temperature of 250° C. or higher.

15. The fibrous basic magnesium sulfate filler-containing master batch composition of claim 9, wherein the component (E) is selected from the group consisting of liquid paraffin, silicone oil, paraffin wax, microcrystalline wax, polyethylene wax and silicone wax.

16. The fibrous basic magnesium sulfate filler-containing master batch composition of claim 9, wherein the composition contains the component (D) in an amount of 0.1 to 5.0 weight parts per the total amount of the components (A), (B) and (C) and in an amount of 0.2 to 7.0 weight parts per 100 weight parts of the component (B).

17. The fibrous basic magnesium sulfate filler-containing master batch composition of claim 9, wherein the composition contains the component (E) in an amount of 0.03 to 10.0 weight parts per the total amount of the components (A), (B) and (C) and in an amount of 0.06 to 15.0 weight parts per 100 weight parts of the component (B).
